(19) United States
(12) Patent Application Publication
(10) Pub. No.: US 2008/0016923 A1
(43) Pub. Date: Jan. 24, 2008

(54) MAGNETIC LOCK

(76) Inventor: Chun-Hong ZHENG, San Chung City (TW)

Correspondence Address: LEONG C LEI, PMB # 1008, 1867 YGNACIO VALLEY ROAD, WALNUT CREEK, CA, 94598, US

(21) Appl. No.: 11/420,225

(22) Filed: May 25, 2006

(51) Int. Cl. E05B 65/10

(52) U.S. Cl. 70/92

(57) ABSTRACT

A magnetic lock structure is disclosed. The lock comprises a metallic plate mounted at the edge of a door panel; a lock body mounted within the door frame of the door panel at a position corresponding to the metallic plate, and at least one end of the lock body being a control section interiorly mounted with a video lense, and the lock body generates a magnetic force when the door panel is closed to attract the metallic plate and if the door opened, the video lense is triggered to monitor the surrounding of the door.

### BACKGROUND OF THE INVENTION

(a) Technical Field of the Invention

The present invention relates to lock, and in particular, to magnetic lock possessing video and monitoring function by means of frequency signal control.

(b) Description of the Prior Art

FIG. 1 is a conventional magnetic lock structure having a locking lock body 4 mounted onto the top edge of a door frame 3. A metallic plate 41 is provided at a position corresponding to a door panel 31. The lock body 4 becomes a magnetic body with magnetic force to be attracted to the metallic plate 41 such that the door panel 31 and the door frame 3 are locked to each other when a current passes through the lock body 4. When the current supply is cut off, the locking between the door panel 31 and the door frame 3 are released. This conventional magnetic lock is commonly found in the market and is controlled by a card, finger print or infra-red (IR) sensor. However, for this magnetic lock, a door opening limiting device 32 (shown in FIG. 4) has to be matched with the door panel 31, and the limiting device 32 pulls back an opened door panel 31 so as to facilitate the lock body 4 to attract to the metallic plate 41. In most situation, the opening angle of the door panel 31 is too wide and will not be restored to its closed position. To avoid this, an alarm indicator or light indicator is employed to alert that the door panel 31 is opened and yet to close, or a video monitor is employed to monitor the status of door closing or opening. Such precaution to the conventional magnetic lock increases the cost of installation and maintainance, and the integration of individual system is rather complicated. In view of the drawback, it is an object of the present invention to provide a magnetic lock which solve the above drawback.

### SUMMARY OF THE INVENTION

The primary purpose of the present invention is to provide a magnetic lock comprising a metallic plate mounted at the edge of a door panel; a lock body mounted within the door frame of the door panel at a position corresponding to the metallic plate, and at least one end of the lock body being a control section interiorly mounted with a video lense, and the lock body generates a magnetic force when the door panel is closed to attract the metallic plate and if the door opened, the video lense is triggered to monitor the surrounding of the door.

Yet another object of the present invention is to provide a magnetic lock, wherein the control section is mounted with a frequency sensing device to receive externally the frequency control signal so as to control the locking of the door panel.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional magnetic lock mounted onto the edge of the door panel.

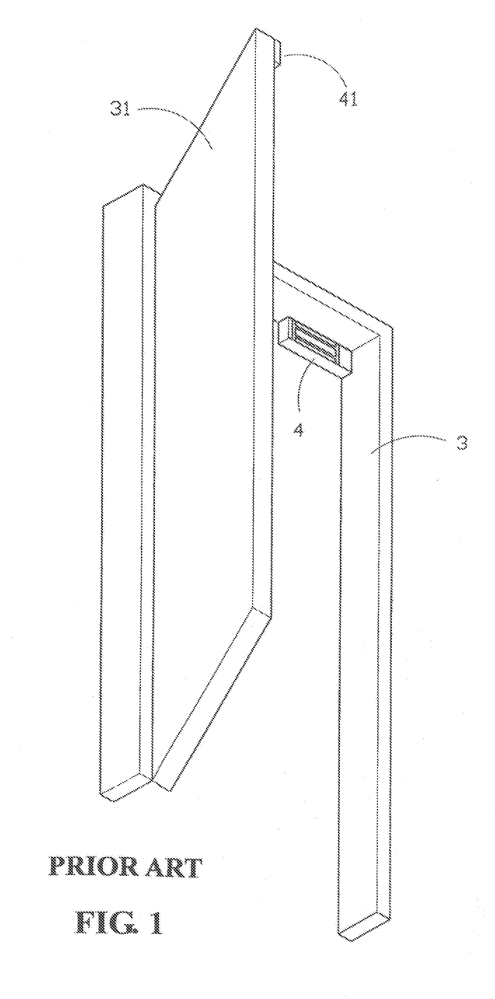

FIG. 2 is a perspective exploded view of the magnetic lock of the present invention.

FIG. 3 is a schematic lateral view of the magnetic lock of the present invention.

FIG. 4 is a schematic view showing the application of the magnetic lock of the present invention.

FIG. 5 is another preferred embodiment in accordance with the present invention.

### DETAILED DESCRIPTION OF THE PREFERRED EMBODIMENTS

The following descriptions are of exemplary embodiments only, and are not intended to limited the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

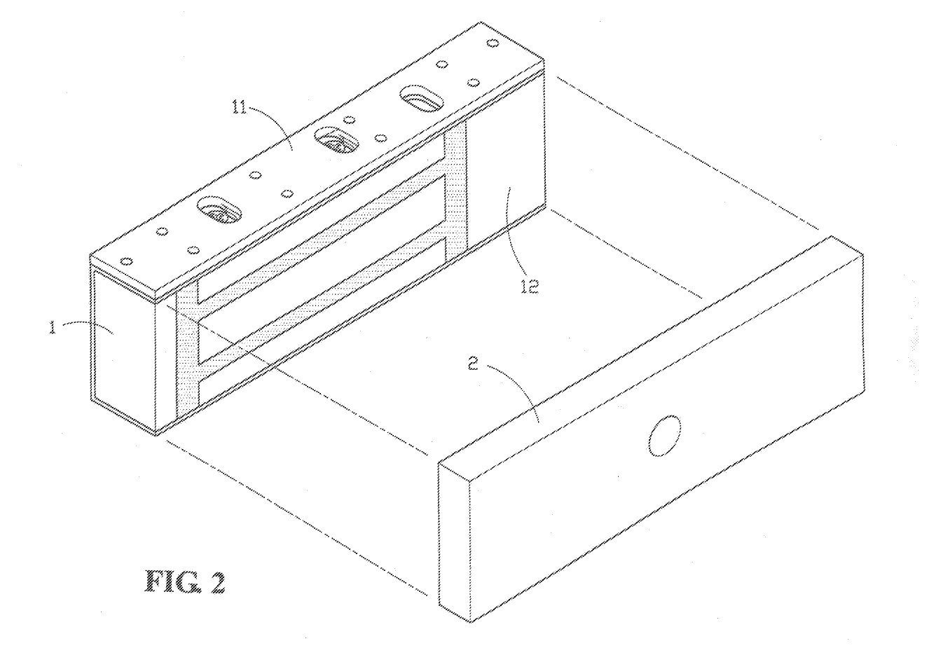

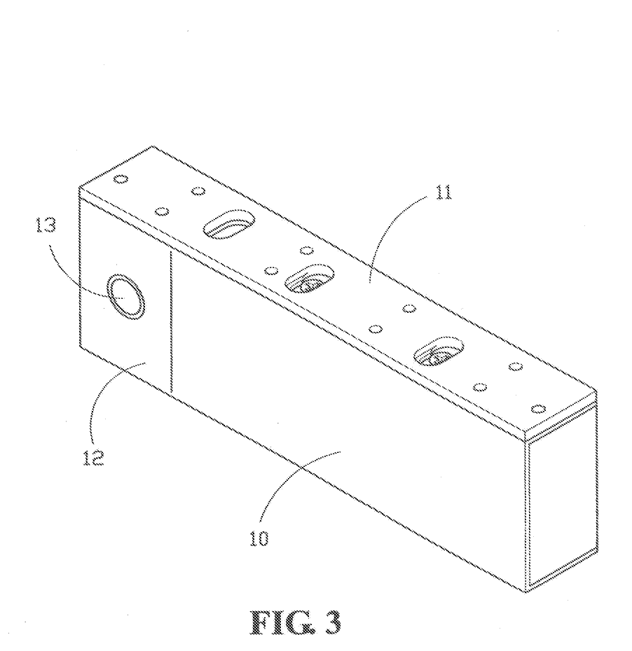

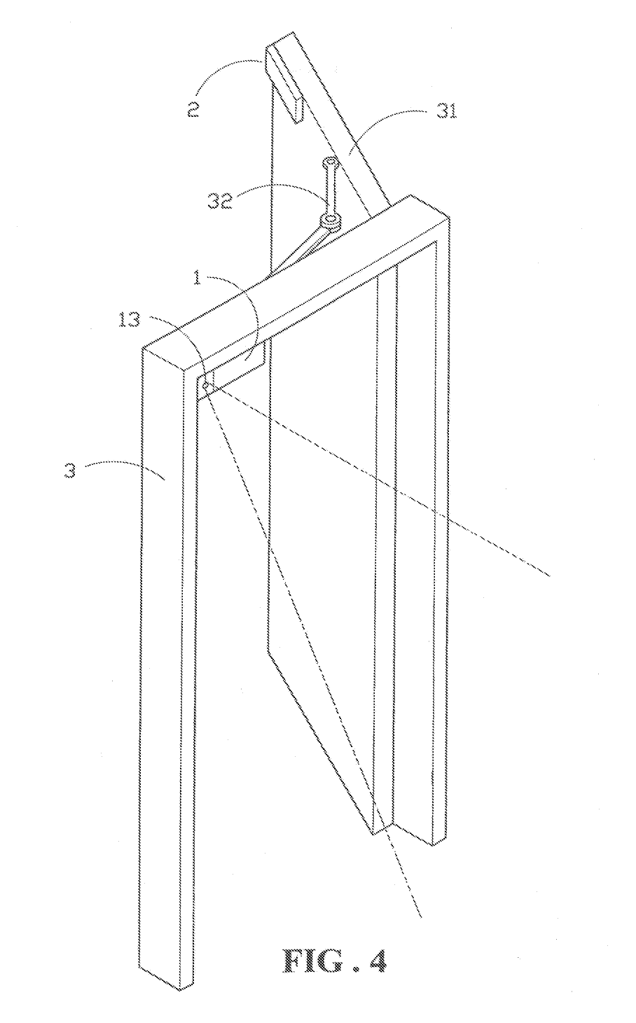

Referring to FIGS. 2 to 4, there is shown a magnetic lock comprising a magnetic lock body 1, and a metallic plate 2. The metallic plate 2 is mounted at the lateral edge of a door panel 31 and the metallic lock body 1 is mounted to the inner edge of a door frame 3 by means of a securing plate 11, corresponding to the metallic plate 2. When the door panel 31 is closed, an electric current passes through to generate a magnetic force so that the metallic plate 2 is attracted to form a locked door with the door panel 31. One end of the lock body 1 is a control section 12 mounted internally with a frequency sensing device and at least a video lense 13. The frequency sensing device receives the external frequency control signal to control the lock body 1 from engaging with the door panel 31. The video lense 13 monitors the surroundings of the door frame 3 and the passage path when door panel 31 is opened so as to ensure the door is closed and to provide video function.

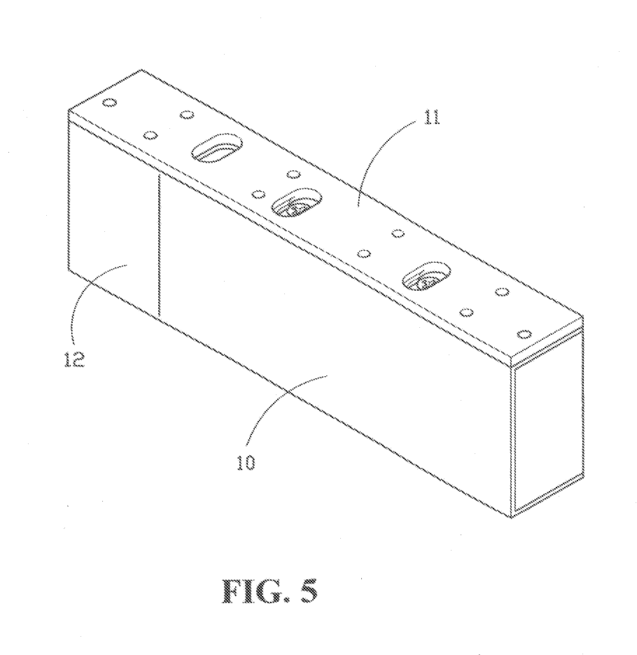

FIG. 5 is another preferred embodiment in accordance with the present invention. The magnetic lock 10 is installed onto a door structure. In this preferred embodiment, the video lense 13 is omitted and only the frequency sensing device is installed such that the magnetic lock provides only the function of a lock and the controlling of the lock.

In accordance with the present invention, the video lenses can be either installed at the front edge or the read edge of the lock body.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A magnetic lock comprising:
a metallic plate mounted at the edge of a door panel;
a lock body mounted within the door frame of the door panel at a position corresponding to the metallic plate, and at least one end of the lock body being a control section interiorly mounted with a video lense, and the lock body generates a magnetic force when the door panel is closed to attract the metallic plate and if the door opened, the video lense is triggered to monitor the surrounding of the door.

2. The lock of claim 1, wherein the control section is mounted with a frequency sensing device to receive externally the frequency control signal so as to control the locking of the door panel.

3. The lock of claim 1 or 2, wherein the video lense is positioned at the front edge of the lock body.

4. The lock of claim 1 or 2, wherein the video lense is positioned at the rear edge of the lock body.
